(19) United States
(12) Patent Application Publication
(10) Pub. No.: US 2023/0304327 A1
(43) Pub. Date: Sep. 28, 2023

(54) ANTI-THEFT BARRIER FOR AUTOMATIC TELLER MACHINE

(71) Applicant: Robert Farrell, Lake Barrington, IL (US)

(72) Inventor: Robert Farrell, Lake Barrington, IL (US)

(21) Appl. No.: 18/124,551

(22) Filed: Mar. 21, 2023

Related U.S. Application Data
(60) Provisional application No. 63/322,359, filed on Mar. 22, 2022.

(51) Int. Cl. E05B 65/467; G07F 19/00

(52) U.S. Cl. CPC E05B 65/467; G07F 19/20

(57) ABSTRACT

An anti-theft barrier for an automatic teller machine is provided. The anti-theft barrier has a first post having a sleeve hinge, a second post having a secure locking housing and a rotating barrier arm. The rotating barrier arm has a first end pivoted from the first post and a second end which locks into the housing of the second post. The housing has an internally hidden and protected lock and bolt and an externally penetrating latch. The anti-theft barrier reduces the chances of attack by deterring unauthorized individuals from being able to unlock the rotating barrier arm to potentially damage or illegally remove the automatic teller machine.

### REFERENCE TO RELATED APPLICATIONS

This application claims priority to U.S. Provisional Application No. 63/322,359 filed on Mar. 22, 2022, the entire contents of which are incorporated by reference herein.

### BACKGROUND OF THE INVENTION

An anti-theft barrier for an automatic teller machine is provided. The anti-theft barrier has a first post having a sleeve hinge, a second post having a secure locking housing and a rotating barrier arm. The rotating barrier arm has a first end pivoted from the first post and a second end which locks into the housing of the second post. The housing has an internally hidden and protected lock and bolt and an externally penetrating latch. The anti-theft barrier reduces the chances of attack by deterring unauthorized individuals from being able to unlock the rotating barrier arm to potentially damage or illegally remove the automatic teller machine.

Protective barriers for automatic teller machines are known. For example, U.S. Pat. No. 8,438,885 to Calder discloses an apparatus for securing cassettes housed within an automatic teller machine (ATM). The apparatus comprises at least one barrier and a supporting structure for supporting at least one barrier. Each barrier is formed and arranged to be associated with a pair of adjacent cassettes and to be movable between a first position in which the barrier prevents removal of a pair of adjacent cassettes in use of the apparatus along their respective removal paths. The barrier is moveable to a second position in which the barrier prevents removal of one cassette of the pair of adjacent cassettes along its removal path and to a third position in which the barrier prevents removal of the other cassette of the pair of adjacent cassettes along its removal path. In use, only one cassette of a pair of adjacent cassettes is removable along its removal path when the barrier is in the second or third position. The apparatus is further formed and arranged so that the barrier (or barriers) can be moved to a ‘service’ position so that both cassettes can be accessed and removed along their removal paths and for servicing of the ATM.

Further, U.S. Pat. No. 7,278,284 to James discloses a lock box assembly for enclosing and protecting a plastic security seal on the latch assembly of the door on a cargo container or trailer. The lock box includes first and second box members that together form an enclosure for the hasp assembly that holds the seal. Cooperating latch arm slots in the sides of the box members capture the latch arm, thereby securing the lock box to the latch assembly and preventing access to the seal. Aligned holes in the sides of the box members receive a lock pin. This configuration provides a lock box that is simple in design and easy to attach and remove using any conventional lock pin. The box is secured to the latch assembly by capturing the latch arm in the slots, eliminating the need for any structure to pass through the hasps, leaving the seal undisturbed.

However, these patents fail to describe an anti-theft barrier for an automatic teller machine which is easy to use. Further, these patents fail to provide an anti-theft barrier for an automatic teller machine which provides heightened security for an automatic teller machine and deters attacks.

### SUMMARY OF THE INVENTION

An anti-theft barrier for an automatic teller machine is provided. The anti-theft barrier has a first post having a sleeve hinge, a second post having a secure locking housing and a rotating barrier arm. The rotating barrier arm has a first end pivoted from the first post and a second end which locks into the housing of the second post. The housing has an internally hidden and protected lock and bolt and an externally penetrating latch. The anti-theft barrier reduces the chances of attack by deterring unauthorized individuals from being able to unlock the rotating barrier arm to potentially damage or illegally remove the automatic teller machine.

An advantage of the present anti-theft barrier for an automatic teller machine is that the present anti-theft barrier for an automatic teller machine has an interior housing which stores the locking mechanism of the anti-theft barrier arm of the device.

Still another advantage of the present anti-theft barrier for an automatic teller machine is that the present anti-theft barrier for an automatic teller machine reduces scratches and rust which otherwise occur on other standard anti-theft barriers.

Yet another advantage of the present anti-theft barrier for an automatic teller machine is that the present anti-theft barrier for an automatic teller machine deters attacks on both the barrier and the automatic teller machine itself.

For a more complete understanding of the above listed features and advantages of the anti-theft barrier reference should be made to the detailed description and the drawings. Further, additional features and advantages of the invention are described in, and will be apparent from, the detailed description of the preferred embodiments.

### BRIEF DESCRIPTION OF THE DRAWINGS

FIG. 1 illustrates a perspective view of the anti-theft barrier for an automatic teller machine wherein the barrier arm is in the first (or “locked”) position.

FIG. 2 illustrates a perspective view of the anti-theft barrier for an automatic teller machine wherein the barrier arm is in the second (or “opened”) position.

FIG. 3 illustrates a front view of the anti-theft barrier device wherein the barrier arm is in the first position.

FIG. 4 illustrates a top view of the anti-theft barrier device wherein the barrier arm is in the first position.

FIG. 5 illustrates a detailed view of the interior of the housing of the second post.

FIG. 6 illustrates a perspective view of the anti-theft barrier for an automatic teller machine with the automatic teller machine removed.

### DETAILED DESCRIPTION OF THE PREFERRED EMBODIMENTS

An anti-theft barrier for an automatic teller machine is provided. The anti-theft barrier has a first post having a sleeve hinge, a second post having a secure locking housing and a rotating barrier arm. The rotating barrier arm has a first end pivoted from the first post and a second end which locks into the housing of the second post. The housing has an internally hidden and protected lock and bolt and an externally penetrating latch. The anti-theft barrier reduces the chances of attack by deterring unauthorized individuals from being able to unlock the rotating barrier arm to potentially damage or illegally remove the automatic teller machine.

Referring now to the figures, in an embodiment, an anti-theft barrier 1 for an automatic teller machine 100 is provided. The anti-theft barrier 1 has a first post 10, a second post 20 and a barrier arm 50. The first post 10 is typically located at or near a first side of the automatic teller machine 100 and the second post 20 is typically located at or near the second side of the automatic teller machine 100. The anti-theft barrier 1 is preferably made partially of a durable non-corrosive metal such as stainless steel, specifically the bearings located at the first post 10 which allow the barrier arm 50 to rotate. The stainless steel bearings preclude ferrous-to-ferrous metal contact with the first post 10, thereby preventing corrosion.

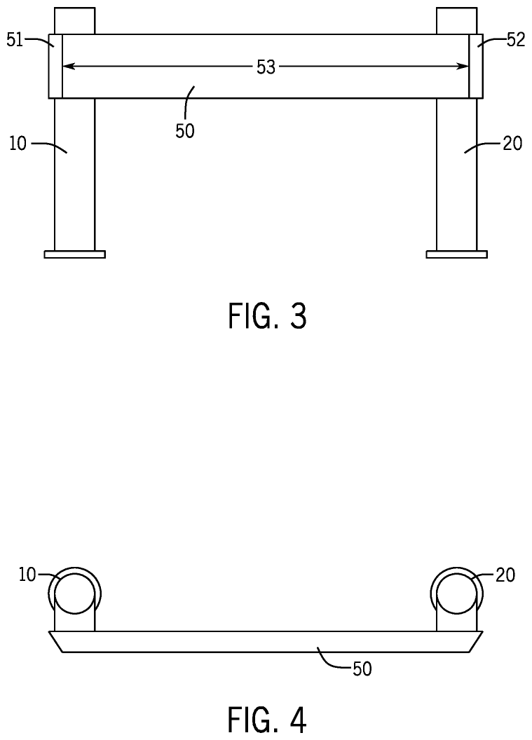

In an embodiment, the barrier arm 50 of the anti-theft barrier 1 has a first end 51 and a second end 52. A length 53 (FIG. 3) defines the distance from the first end 51 to the second end 52 of the barrier arm 50. Preferably, the length 53 is equal to or greater than a width of the automatic teller machine 100. Located at the first end 51 of the barrier arm 50 may be a sleeve hinge 55 which slides over the top of the first post 10. The sleeve hinge 55 allows the barrier arm 50 to rotate with respect to the bottom of the first post 10. More specifically, the first end 51 of the barrier arm 50 is permanently secured to the sleeve hinge 55 of the first post 10 while the second end 52 of the barrier arm 50 may be temporarily locked or unlocked to the second post 20 as needed. As a result, the second end 52 of the barrier arm 50 rotates. In one embodiment, the sleeve hinge 55 allows the barrier arm 50 to rotate approximately one hundred and eighty degrees. Allowing the second end 52 of the barrier arm 50 to rotate away from the second post 20 allows authorized workers to install, remove or repair the automatic teller machine 100.

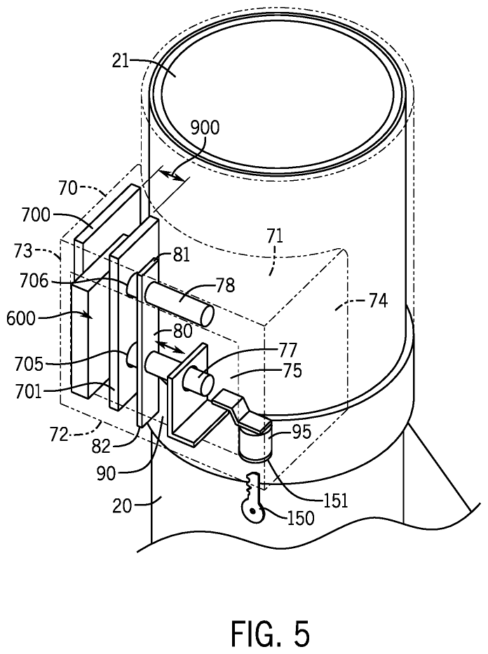

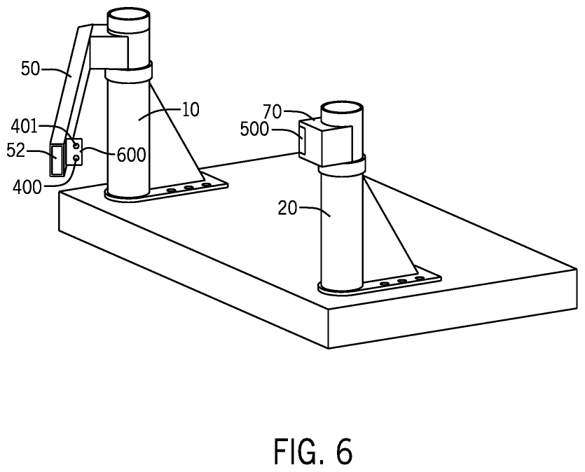

In an embodiment, the second post 20 may have a top 21 and a bottom 22. The bottom 22 is secured to the ground or other base 28 while the top 21 is located vertically above the bottom 22. At or near the top 21 of the second post 20 may be a permanently secured housing unit 70. The housing unit 70 is preferably cubic in shape, extending from the front of the second post 20. The housing unit 70 has a top 71, a bottom 72, a first side 73 and a second side 74. The back of the housing unit 70 is permanently secured to the second post 20. The back of the housing unit 70 is preferably arched-shape, therein matching the arched-shaped of the front of the second post 20. The housing unit 70 also has an interior 75 with locking components as best illustrated in FIG. 5.

Located within the interior 75 of the housing unit 70 are components of a locking mechanism which remain secured and inconspicuous so as to deter and reduce attacks on the barrier 1 and, therefore, the automatic teller machine 100 itself. The interior 75 of the housing unit 70 has a first bolt 77 which moves from a first position to a second position. In the first position, the second end 52 of the barrier arm 50 is securely locked to (or inside) the housing unit 70 of the second post 20. In the second position, the second end 52 is not locked to (or inside) the housing unit 70 of the second post 20. In an embodiment, a second bolt 78 is also used in the same manner as the first bolt 77 for additional security and durability.

The housing unit 70 may have a latch 80. The latch 80 may have a first end 81 and a second end 82. The first end 81 may be permanently secured within the housing unit 70 while the second end 82 of the latch 80 remains permanently outside of the housing unit 70. More specifically, the second end 82 of the latch 80 may pass through an opening slot 90 of the bottom 72 of the housing unit 70.

In an embodiment, brace plates 700, 701 are permanently welded to the interior 75 of the housing unit 70 of the second post 20. A gap 900 is located between the two brace plates 700, 701. The brace plates 700, 701 have openings 705, 706 for receiving the bolts 77, 78.

A key 150 may be inserted into an opening 151 of the housing unit 70 and may be used to rotate a lock 95 located within the interior 75 of the housing unit 70. The key 150, when properly inserted and turned, may activate the lock 95 to unlock the housing unit 1 when the latch 80 is moved from the first position to the second position. When the key 150 is turned, the bolts 77, 78 move horizontally passing through the brace plate 701 and also a permanent securing plate 600 of the second end 52 of the barrier arm 50.

In an embodiment, the latch 80 is permanently attached within the interior 75 of the housing unit 70 whereas the permanent securing plate 600 is permanently secured to the second end 52 of the barrier arm 50. As a result, when the bolts 77, 78 pass through both the permanent securing plate 600 of the second end 52 of the barrier arm 50 and the movable latch 80 of the housing unit 70 the barrier arm 50 is locked to the second post 20.

When the latch 82 is moved by the user pushing or pulling the bottom of the latch 82 (which extends through an opening at the bottom of the housing unit 70) to the left or to the right, the bolts 77, 78 (which are permanently secured to the latch 82) are moved so that the bolts 77,78 passes through the permanent securing plate 600 of the barrier arm 50 in the locked position shown in FIG. 2 and do not pass through the permanent securing plate 600 in the unlocked position. In particular, to unlock the barrier arm 50 from the second post 20, a user turns the key 150 and then uses his/her finger to move the latch 82 sideways (from the underside of the housing). When the latch 82 is moved, the bolts 77, 78 move out of the holes of both the plate 701 of the second post 20 and the holes of the permanent securing plate 600 of the barrier arm 50. Only then may the barrier arm 50 be pulled away from the second post 20. To lock the barrier arm 50 to the second post 20, the reverse procedure is followed.

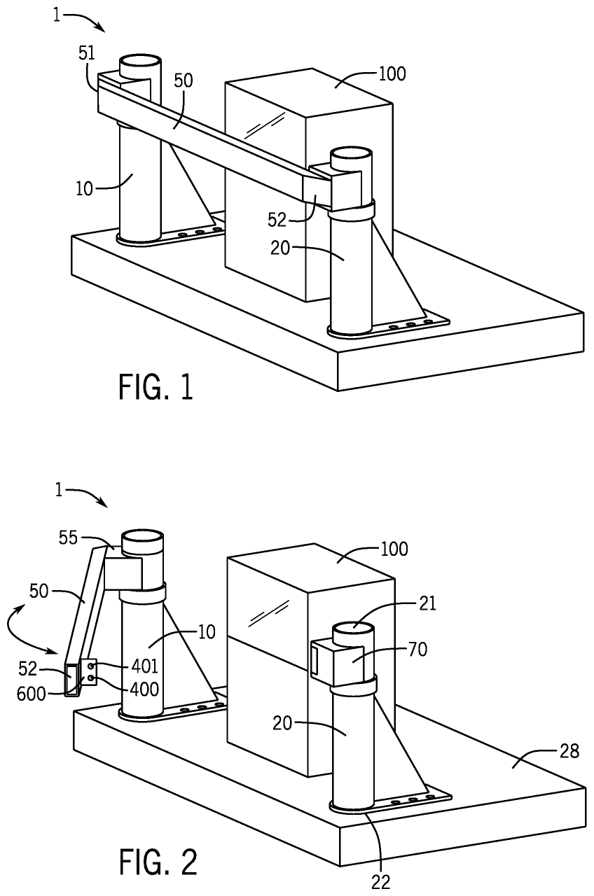

In an embodiment, the permanent securing plate 600 has a first opening 400 (or hole) and a second opening (or hole) 401. When the barrier arm 50 is rotated to the “locked” position of FIG. 1, the securing plate 600 of the second end 52 of the barrier arm 50 moves into the gap 900 located between the two brace plates 700, 701 of the interior 75 of the housing unit 70. When the barrier arm 50 is fully in the locked position of FIG. 1, the holes 400, 401 of the permanent securing plate 600 aligns with the holes 705, 706 of the brace plates 700, 701 and the bolts 77, 78 may then pass through all the holes, 400, 401, 705, 706 to lock the barrier arm 50 to the second post 20.

While the figures illustrate the interior components of the housing unit 70, the front of the housing unit 70 is covered by a secure plate; preferably metal, therein protecting and concealing the interior locking components. More specifically, when the barrier arm 50 is locked to the second post 20, the unique housing unit 70 completely covers the internal locking mechanism of the device 1 on top of the locking mechanism, on the back of the locking mechanism (via the second post), and on both sides of the locking mechanism (which includes the interior components). Only the underside (or bottom) of the housing unit 70 is partially exposed. The hidden access to the locking mechanism of the housing unit 70 therein deters theft or vandalism of the locking mechanism (the interior components) of the housing unit 70 of the device 1.

Finally, in an embodiment, an opening 500 of the front of the housing unit 70 may receive the permanent securing plate 600 of the second end 52 of the barrier arm 50. The opening 500 of the housing unit 70 may be completely covered up by the second end of the barrier arm 50 when the barrier arm 50 is secured to the second post 20. As a result, the front of the housing unit 70 lacks any openings when the barrier arm is secured to the second post 20. In particular, in an embodiment, the barrier arm 50 completely covers the housing unit 70 so that there are no openings on the front, the top, or the sides of the housing unit when the barrier arm 50 is secured to the housing unit 70. Instead, the only opening is on the bottom of the housing unit 70 when the barrier arm 50 is secured to the second post 20. As a result, the device 1 is secure, unlike the exposed padlocks on most other barrier devices.

Although embodiments of the invention are shown and described therein, it should be understood that various changes and modifications to the presently preferred embodiments will be apparent to those skilled in the art. Such changes and modifications may be made without departing from the spirit and scope of the invention and without diminishing its attendant advantages.

I claim:

1) An anti-theft automatic teller machine barrier comprising:
a first post having a top end and a bottom end;
a second post having a top end and a bottom end;
a barrier arm secured to the first post;
a housing unit located on the second post;
wherein the housing unit has a top surface, a bottom, a first side, a second side, a front, and an interior;
a locking mechanism located within the interior of the housing unit;
wherein the housing unit has an opening on the bottom; and
wherein the front of the housing unit lacks any openings when the barrier arm is secured to both the first post and the second post.

2) The anti-theft automatic teller machine barrier of claim 2 further comprising:
stainless steel sleeve and disc bearings located at the first post which allow the barrier arm to rotate.

3) The anti-theft automatic teller machine barrier of claim 1 further wherein the housing unit has a arched-shaped back which is secured to the second post.

4) The anti-theft automatic teller machine barrier of claim 1 further comprising:
a latch having a top end and a bottom end wherein the top end of the latch is permanently secured within the interior of the housing unit and wherein the bottom end of the latch extends beyond the bottom of the housing unit through the opening of the bottom of the housing unit.

5) The anti-theft automatic teller machine barrier of claim 4 further comprising:
a first bolt located within the interior of the housing unit wherein the first bolt is permanently secured to the latch and wherein the first bolt passes through a securing plate which is permanently secured to the barrier arm when the anti-theft automatic teller machine is locked.

6) The anti-theft automatic teller machine barrier of claim 1 further comprising:
a lock key hole located on the bottom of the housing unit wherein the lock key hole receives a key to unlock the housing unit.
